(19) United States
(12) Patent Application Publication
(10) Pub. No.: US 2024/0116066 A1
(43) Pub. Date: Apr. 11, 2024

(54) DIRECT INJECTION SPRAYING ASSEMBLY COMPRISING DIRECT A DOSING INTERFACE

(71) Applicant: EXEL INDUSTRIES, EPERNAY (FR)

(72) Inventors: Daniel Tragus, Coye la Forêt (FR); Philippe Provenaz, MEYLAN (FR); Colin Chaballier, Châlons en Champagne (FR); Thibault Bacle, LYON (FR)

(21) Appl. No.: 18/483,483

(22) Filed: Oct. 9, 2023

(30) Foreign Application Priority Data
Oct. 11, 2022 (FR) 2210394

(51) Int. Cl. B05B 7/32; A01C 23/00; A01M 7/00

(52) U.S. Cl. CPC B05B 7/32; A01C 23/007; A01M 7/0092

(57) ABSTRACT

The present invention relates to a spraying assembly comprising an injection device, a first hydraulic circuit for conveying carrier liquid to a spray nozzle, the first hydraulic circuit comprising, upstream of the spray nozzle, an injection section, a second hydraulic circuit for conveying the active substance to the injection device, under an injection pressure greater than the carrier liquid circulation pressure, the injection device comprising a direct dosing interface comprising a plurality of through-holes in the injection section of the first hydraulic circuit, and the injection device further comprising at least one corresponding actuator configured to open or close each through-hole so as to allow a determined dosing of active substance to pass through at least one open hole to be injected into the carrier liquid stream.

### TECHNICAL FIELD

The present invention relates to the field of agricultural spraying and is more specifically directed to a direct injection spraying assembly. More particularly, the spraying assembly according to the invention comprises an active substance direct dosing interface upstream of at least one spray nozzle.

### BACKGROUND

A well-known issue in the field of agricultural spraying relates to dosing of active substance sprayed, which has to be adapted to the need. On a continuous basis, the best match is sought between the need for crop protection and the amount of ingredient sprayed. Direct injection techniques have been developed for this purpose.

Direct injection consists in injecting an active substance in a continuous water jet directly upstream of the spray nozzle.

Document FR 2964047 A1 describes an example of a direct injection spraying assembly. In this document, the presence of injectors directly upstream of the spray nozzles of a spraying assembly is especially described. Each injector is capable of being sealed by a valve to avoid over- or under-dosing. By virtue of this document, the principle of actively adjusting flow rate of the active substance at each spray nozzle is known. A direct injection spraying assembly adapted to deliver an active substance injected into a carrier liquid via a set of nozzles with a variable flow rate of active substance directly adjusted at the spray nozzles is thus known.

In a known manner, in this type of known spraying assembly, injectors are thus configured to inject the active substance into the carrier liquid stream, at a desired flow rate. The injectors comprise holes that can be opened or closed by means of actuators such as electromagnetic valves. The injectors are directly placed upstream of the spray nozzles.

In the state of the art relating to direct injection spraying assemblies, the flow rate of active substance injected into a carrier liquid stream is thus modulated directly upstream of the spray nozzles. By controlling the flow rate of active substance injected, by virtue of adapted injector control, prevention of over- or under-dosing can be improved.

However, dosing of active substance injected into the carrier liquid stream cannot be precisely, directly and continuously controlled.

Therefore, there is a need for a spraying assembly for accurately and continuously dosing the active substance injected into a carrier liquid stream in a direct injection spraying assembly.

A fortiori, there is a need for such a spraying assembly, further having a wide range of active substance dosing in a carrier liquid stream.

To meet at least in part this need, the invention provides the use, in a direct injection spraying assembly, of a direct dosing interface comprising a plurality of holes, in particular nano-holes and/or micro-holes, in particular of different sizes, the holes being coupled to actuators controlled so as to open or close them. In this way, precise and continuous dosing of one or more active substances into a carrier liquid stream is achieved.

The active substances proportioned are injected into a carrier liquid stream directly upstream of the spray nozzles.

### SUMMARY OF THE INVENTION

More precisely, one object of the invention is a spraying assembly comprising a first tank configured to contain a carrier liquid, for example water, and a second tank configured to contain an active substance, at least one spray nozzle, at least one injection device, a first hydraulic circuit to convey the carrier liquid from the first tank to the spray nozzle, under a carrier liquid circulation pressure, the first hydraulic circuit comprising, upstream of the spray nozzle, an injection section, a second hydraulic circuit to convey the active substance from the second tank to the injection device, under an injection pressure greater than the carrier liquid circulation pressure, the active substance injection device being connected to the injection section of the first hydraulic circuit and being configured to inject active substance into a carrier liquid stream circulating in the first hydraulic circuit, the injection device comprising, at the end of the second hydraulic circuit opposite to the second tank, a direct dosing interface comprising a plurality of through-holes leading into the injection section of the first hydraulic circuit, and the injection device comprising at least one actuator corresponding to the plurality of through-holes, configured to open or close the plurality of through-holes, so as to allow a determined dosing of active substance to pass through at least one open through-hole of the plurality of through-holes of the direct dosing interface to be injected into the carrier liquid stream, in such a way as to form a mixture comprised of carrier liquid and proportioned active substance to be sprayed through the at least one spray nozzle, for the purpose of crop treatment.

By virtue of the invention, it is possible to benefit from a wide dosing range of active substance(s) in a carrier liquid, directly upstream of the nozzles of a spraying system. Furthermore, the invention makes it possible to ensure constant dosing regardless of the speed of movement of the spraying system or that of the nozzle in relation to the ground.

For example, the at least one actuator is a piezoelectric actuator.

For example, the at least one actuator is a pneumatic actuator, and the spraying assembly comprises a compressed air circuit to enable actuation of the pneumatic actuators.

The at least one actuator is especially a piezoelectrically actuated pneumatic actuator.

For example, the at least one actuator is a solenoid valve.

Advantageously, the at least one actuator is controlled in opening and closing by a pulse width modulation generator.

Advantageously, the injection pressure is at least one bar higher than the carrier liquid circulation pressure.

In practice, the difference between the injection pressure and the circulation pressure depends in particular on the viscosity of the active substance in relation to that of the carrier liquid.

In particular, not all the holes have the same diameter, the different diameters of the holes being especially between 50 μm and 300 μm.

According to one embodiment, the spraying assembly comprises a plurality of holes and a set of corresponding actuators, and further comprises a calculation unit for determining, from a dosing setpoint, the amount of active substance to be injected into the carrier liquid stream and for controlling opening and closing of the corresponding number of holes of the direct dosing interface.

According to one embodiment, the calculation unit determines a frequency of opening and closing for each hole of a set of holes among the holes of the direct dosing interface, based on a carrier liquid flow rate in the first hydraulic circuit. The frequency of opening and closing can especially vary from a hole to another hole, for more accurate dosing at the nozzle.

According to one embodiment, the active substance circulates along an injection direction and the carrier liquid circulates along a direction of circulation when injecting the active substance into the carrier liquid, the injection direction of the active substance being substantially parallel to the direction of circulation of the carrier liquid, or forming with it an angle of between 0° and 90°.

Advantageously, the at least one spray nozzle comprises a nozzle head forming a chamber directly upstream of an outlet of the spray nozzle, and the injection section forms a circular portion housed in the chamber, and the spraying assembly comprises a plurality of holes distributed in a star shape on the injection section so as to inject active substance into the nozzle head.

In this case, mixing the active substance in the carrier liquid is even better and directly carried out in the nozzle head.

Advantageously, the spraying assembly comprises a plurality of spray nozzles and one or more dosing interfaces dedicated to a spray nozzle or a plurality of spray nozzles.

According to one embodiment, the spraying assembly comprises an active substance recirculation line extending between the at least one spray nozzle and the second tank to ensure continuous circulation of the active substance in the spraying assembly.

Advantageously, the spraying assembly comprises at least two second active substance tanks respectively connected to corresponding second hydraulic circuits each having a direct dosing interface with the first hydraulic circuit.

### BRIEF DESCRIPTION OF THE DRAWINGS

The invention will be better understood upon reading the following description, given solely as an example, and by referring to the accompanying figures, given as non-limiting examples, wherein identical references are given to similar objects and in which:

FIG. 1 is a schematic representation of the spraying assembly according to a first embodiment of the invention;

FIG. 2 is a schematic representation of the spraying assembly according to a first embodiment of the invention. It should be noted that the figures disclose the invention in detail in order to implement the invention, said figures can of course be used to better define the invention where applicable.

### DETAILED DESCRIPTION OF THE INVENTION

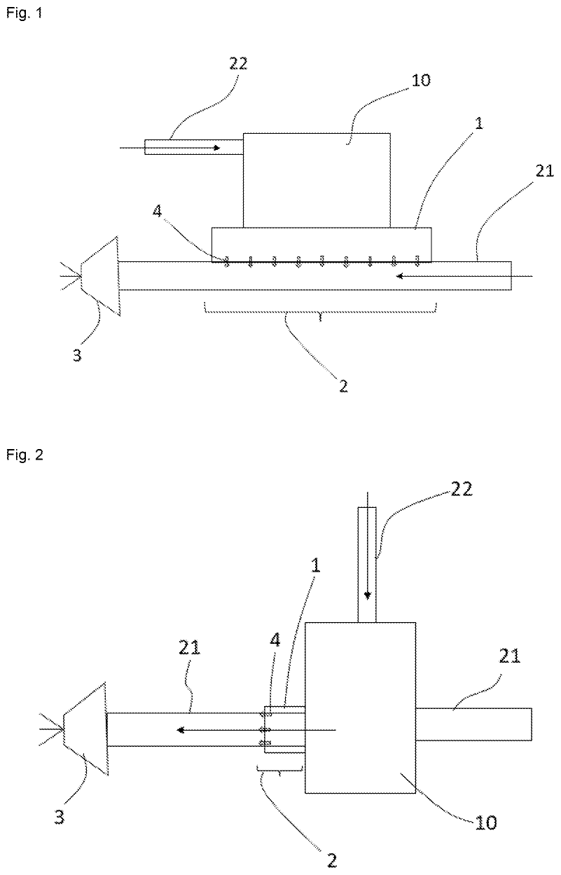

The invention relates to a direct injection spraying assembly. Such a spraying assembly is schematically represented in FIG. 1 and, according to another embodiment, in FIG. 2.

The spraying assembly comprises a first tank comprising a carrier liquid, especially water, and a second tank containing an active substance especially a herbicide, fungicide, insecticide, or fertilizer. According to one embodiment, the spraying assembly comprises several second tanks that may contain different active substances. In this case, said different active substances may be simultaneously proportioned into the carrier liquid.

The spraying assembly according to the invention also comprises at least one spray nozzle 3, preferably a plurality of spray nozzles 3 distributed along a spray ramp. For example, the spray ramp is arranged in sections, each comprising a set of spray nozzles 3 configured to be controlled identically.

Each of the first and second tanks is connected to the spray nozzles 3 via a first hydraulic circuit 21 and a second hydraulic circuit 22, respectively. When there are several second tanks, especially containing different active substances, there are also several second hydraulic circuits 22, each having a respective interface with the first hydraulic circuit 21.

Preferably, the first and second hydraulic circuits 21, 22 are closed circuits by means of recirculation lines, the first hydraulic circuit 21 looping back into the first tank and the second hydraulic circuit 22 looping back into the second tank.

The spraying assembly comprises in particular an injection device connected between the second hydraulic circuit 22 and an injection section 2 forming part of the first hydraulic circuit 21 and located directly upstream of the spray nozzles 3.

The injection device is configured to inject active substance into a carrier liquid stream circulating in the first hydraulic circuit 21 from the first tank to the spray nozzles 3. To this end, the injection device comprises a direct dosing interface 1 comprising one or more holes to allow injection of active substance into the carrier liquid stream circulating in the injection section 2 of the first hydraulic circuit 21.

The active substance circulates in the second hydraulic circuit 22 under an injection pressure while the carrier liquid circulates in the first hydraulic circuit 21 under a circulation pressure lower than the injection pressure. Preferably, the injection pressure is at least one bar higher than the circulation pressure. For example, the injection pressure is 6 bar and the circulation pressure is 3 bar. In practice, the injection pressure is chosen according to the physicochemical properties of the ingredient, in particular its viscosity.

According to the embodiment of FIG. 1, the direction of circulation of the active substance at the direct dosing interface 1 is substantially orthogonal to the direction of circulation of the carrier liquid. In this case, for the mixture to be most effective, the pressure difference between the injection pressure and the circulation pressure is preferably high, especially greater than two bar, preferably greater than three bar.

According to the embodiment of FIG. 2, the direction of circulation of the active substance at the direct dosing interface 1 is substantially parallel to the direction of circulation of the carrier liquid. In this case, the pressure difference between the injection pressure and the circulation pressure may be less, particularly in the range of one bar.

Thus, the angle formed between the main axis along which the active substance circulates and the main axis along which the carrier liquid circulates, at the direct dosing interface, may in particular be between 0° and 90°. The closer the angle is to 0°, i.e. the direction of circulation of the active substance at the direct dosing interface is substantially parallel to the direction of circulation of the carrier liquid, the easier the injection of active substance into the carrier liquid will be.

The hole(s) of the direct dosing interface 1 are holes, especially substantially circular and which may have a diameter of between 50 μm and 300 μm. According to one embodiment, if there are several holes, the latter may have different diameters.

Each hole is coupled to an actuator 4 controlled to open or close passage of active substance through said hole. Preferably, an actuator 4 is coupled to a single hole. Alternatively, an actuator 4 may be coupled to a group of holes, simultaneously closing or opening all holes of said group of holes. In particular, each actuator is controlled in opening and closing by means of a Pulse Width Modulation (PWM) generator in order to open and close each hole at an opening and closing frequency.

According to one embodiment, a control unit 10 is configured to command opening or closing of a number of holes correspond to a dosing setpoint. Thus, based on a desired active substance dosing corresponding to said dosing setpoint, for example determined by a calculation unit configured for this purpose, the control unit 10 determines the number of holes to be opened, the other holes having to be closed, so as to inject the desired amount of active substance into the carrier liquid, as well as the frequency of opening and closing of each hole.

Especially, the dosing setpoint may depend on various parameters which may vary individually or simultaneously, including the speed of the spraying system, especially the speed of the spray nozzle. The dosing setpoint can be determined according to a mapping of the modulation of doses of active substances to be applied, or according to calculations made on a recognition of the crops to be treated.

In addition, depending on the active substance flow requested in the second hydraulic circuit 22 and the flow rate of carrier liquid circulating in the first hydraulic circuit 21, the calculation unit 10 can determine a set of control signals to: alternately open and close a set of holes among the holes of the direct dosing interface, the opening time and the closing time are variable for each spray nozzle 3.

For example, the control unit 10 determines a set of holes and an alternate opening and closing frequency of the holes of the set of holes. This injects the desired amount of active substance into the carrier liquid stream directly upstream of the spray nozzles 3.

Thus, by way of illustration, according to the invention, a calculation unit 10 can determine dosing of active substance to be sprayed, corresponding to a desired flow rate of active substance at the outlet of the spray nozzle 3, in L/min. The desired flow rate of active substance at the nozzle outlet corresponds to the dosing setpoint.

Depending on the flow rate of carrier liquid conveyed to the spray nozzles 3, and depending on, for example, the speed of movement of the spraying assembly, the control unit 10 determines the amount of active substance to be injected into the carrier liquid at the injection section 2, as a function of time.

For example, the control unit determines, based on the amount of active substance to be injected as a function of time, the number of holes to be opened and/or the frequency of opening and closing of a set of holes among the holes of the direct dosing interface 1 and the duration of opening of the holes. The control unit 10 then generates and transmits corresponding control signals to the actuators.

According to one embodiment, the direct dosing interface comprises at least one hole, for example 32 holes, especially substantially circular and having respectively at least two different diameters among the following diameters: 50 μm, 80 μm, 100 μm, 150 μm; 180 μm; 200 μm; 300 μm.

One advantage of having holes of different sizes is the possibility of having a wider dosing range.

According to one particular embodiment, the spray nozzle(s) 3 of the spraying assembly comprise a nozzle head forming a chamber directly upstream of an outlet of the spray nozzle 3 and the injection section 2 forms a circular portion housed in the chamber. The holes are then distributed in a star shape on the injection section so as to inject active substance into the nozzle head 3.

The actuators 4 are, for example, piezoelectric actuators. Alternatively, the actuators 4 may be pneumo-valve type controlled actuators. In this case, the spraying assembly also comprises a compressed air circuit to ensure opening and closing of the pneumo-valves.

One advantage of the pneumo-valves is that advantage is taken of the compressed air power to close the pneumo-valve. There is no need to provide mechanical force for a spring-loaded closure system for example, which could result in a larger overall size.

According to another embodiment, the actuators 4 are solenoid valves. One advantage related to the use of solenoid valves is that they are easy to drive. The solenoid valves are directly driven and do not require a prior opening of an air circuit, such as pneumo-valves.

1. A spraying assembly comprising a first tank configured to contain a carrier liquid, for example water, and a second tank configured to contain an active substance, at least one spray nozzle, at least one injection device, a first hydraulic circuit to convey carrier liquid from the first tank to the spray nozzle, under a carrier liquid circulation pressure, the first hydraulic circuit comprising, upstream of the spray nozzle, an injection section, a second hydraulic circuit for conveying active substance from the second tank to the injection device, under an injection pressure greater than the carrier liquid circulation pressure, the active substance injection device being connected to the injection section of the first hydraulic circuit and being configured to inject active substance into a carrier liquid stream circulating in the first hydraulic circuit, the injection device comprising, at the end of the second hydraulic circuit opposite to the second tank, a direct dosing interface comprising a plurality of through-holes leading into the injection section of the first hydraulic circuit, and the injection device comprising at least one actuator corresponding to the plurality of through-holes, configured to open or close the plurality of through-holes, so as to allow a determined dosing of active substance through at least one open through-hole of the plurality of through-holes of the direct dosing interface to be injected into the carrier liquid flow, in such a way as to form a mixture comprised of carrier liquid and proportioned active substance to be sprayed through the at least one spray nozzle, for the purpose of crop treatment.

2. The spraying assembly of claim 1, wherein the at least one actuator is a piezoelectric actuator.

3. The spraying assembly of claim 1, wherein the at least one actuator is a pneumatic actuator and the spraying assembly comprises a compressed air circuit to enable the at least one pneumatic actuator to be actuated.

4. The spraying assembly according to claim 3, wherein the at least one actuator is a piezoelectrically actuated pneumatic actuator.

5. The spraying assembly according to claim 1, wherein the at least one actuator is a solenoid valve.

6. The spraying assembly according to claim 1, wherein the at least one actuator is controlled in opening and closing by a pulse width modulation generator.

7. The spraying assembly according to claim 1, wherein the injection pressure is at least one bar higher than the carrier liquid circulation pressure.

8. The spraying assembly according to claim 1, wherein not all the holes of the plurality of through-holes have the same diameter, the different diameters of the holes being especially between 50 μm and 300 μm.

9. The spraying assembly according to claim 1, comprising a set of actuators corresponding to the holes of the plurality of through-holes, the spraying assembly further comprising a calculation unit for determining, from a dosing setpoint, the amount of active substance to be injected into the carrier liquid stream and for controlling opening and closing of the corresponding number of holes of the direct dosing interface.

10. The spraying assembly according to claim 9, wherein the calculation unit determines a frequency of opening and closing for each hole of a set of holes among the holes of the direct dosing interface, based on a carrier liquid flow rate in the first hydraulic circuit.

11. The spraying assembly according to claim 1, wherein the active substance circulates along an injection direction and the carrier liquid flows along a direction of circulation when injecting the active substance into the carrier liquid, the injection direction of the active substance being substantially parallel to the direction of circulation of the carrier liquid, or forming with it an angle between 0° and 90°.

12. The spraying assembly according to claim 1, wherein the at least one spray nozzle comprises a nozzle head forming a chamber directly upstream of an outlet of the spray nozzle, and the injection section forms a circular portion housed in the chamber, and the spraying assembly comprises a plurality of holes distributed in a star shape on the injection section so as to inject active substance into the nozzle head.

13. The spraying assembly according to claim 1, comprising a plurality of spray nozzles and one or more dosing interfaces dedicated to a spray nozzle or a plurality of spray nozzles.

14. The spraying assembly according to claim 1, comprising an active substance recirculation line extending between the at least one spray nozzle (3) and the second tank to ensure continuous circulation of the active substance through the spraying assembly.

15. The spraying assembly according to claim 1, comprising at least two active substance second tanks respectively connected to corresponding second hydraulic circuits each having a direct dosing interface with the first hydraulic circuit.
